(19) United States
(12) Patent Application Publication
(10) Pub. No.: US 2021/0123124 A1
(43) Pub. Date: Apr. 29, 2021

(54) THERMAL BARRIER COATING FILM AND TURBINE MEMBER

(71) Applicant: MITSUBISHI HEAVY INDUSTRIES, LTD., Tokyo (JP)

(72) Inventors: Daisuke KUDO, Tokyo (JP); Taiji TORIGOE, Tokyo (JP); Masahiko MEGA, Tokyo (JP); Shigenari HORIE, Tokyo (JP); Shuji TANIGAWA, Tokyo (JP); Yoshifumi OKAJIMA, Tokyo (JP)

(21) Appl. No.: 16/497,067

(22) PCT Filed: Mar. 28, 2018
(86) PCT No.: PCT/JP2018/012944

§ 371 Date: Sep. 24, 2019

(30) Foreign Application Priority Data
Mar. 28, 2017 (JP) 2017-062063

(51) Int. Cl. C23C 4/11; C23C 4/134; C23C 28/00; F01D 5/28

(52) U.S. Cl. CPC C23C 4/11; C23C 4/134; C23C 28/3215; C23C 28/3455; F05D 2300/514; F05D 2210/12; F05D 2220/32; F05D 2230/90; F05D 2300/2118; F01D 5/288

(57) ABSTRACT

The task is to provide a thermal barrier coating film (13) which exhibits high durability even in a gas turbine that is used under a molten salt environment, such as a heavy oil fired gas turbine, and which can be efficiently formed at low cost without requiring complicated processes, and a thermal barrier coating film (13) configures a turbine member includes a ceramic material thermally sprayed and formed on a base material (10) made of a heat resistant alloy, in which ytterbia partially stabilized zirconia is used as the ceramic material of the film (13), and the porosity of the film (13) is 5% or more and less than 8%.

### TECHNICAL FIELD

The present invention relates to a thermal barrier coating film and a turbine member using the thermal barrier coating film.

Priority is claimed on Japanese Patent Application No. 2017-62063, filed on Mar. 28, 2017, the content of which is incorporated herein by reference.

### BACKGROUND ART

For example, with respect to a high temperature part such as a gas turbine member, in the past, a thermal barrier coating (hereinafter, there is a case where it is referred to as “TBC”) has been applied to the surface of a base material. The thermal barrier coating refers to a coating of a thermal spray material with low thermal conductivity, for example, a porous ceramic-based material with low thermal conductivity, provided on the surface of the base material by thermal spraying, and this can improve the heat shielding properties and durability of the high temperature part.

On the other hand, fuel which is used in a gas turbine is diversified, and needs of not only gas turbines using conventional gas but also gas turbines using low-quality fuel, for example, oil fuel called A-type heavy oil, as fuel are increasing. In such a heavy oil fired gas turbine, the thermal barrier coating is exposed to a molten salt containing sodium sulfate which is generated by sodium, sulfur, or the like contained in the heavy oil, and the molten salt penetrates into the interior of the thermal barrier coating, and thus there is a concern that the thermal barrier coating made of ceramics may be damaged by the penetrated molten salt.

As a technique in which a problem in a molten salt environment in the thermal barrier coating of a heavy oil fired gas turbine has been considered, the technique of PTL 1 has already been proposed.

In the proposal of PTL 1, a thermal barrier coating which is formed on a base material made of a heat resistant alloy has a configuration in which it has a two-layer structure having a thermal barrier layer (porous layer) made of porous ceramics, and a dense environment shielding layer (dense layer) formed on the porous layer and containing ceramic fibers and containing silica as a main component, and each pore of the porous layer is impregnated with a part of the silica of the dense layer. In PTL 1, it is proposed that it is preferable to use stabilized zirconia as the ceramic material of the porous layer which is a thermal barrier layer, and in particular, zirconia partially stabilized by yttria (Y₂O₃) (yttria partially stabilized zirconia; hereinafter, there is a case where it is referred to as “YSZ”) is suitable.

In such a thermal barrier coating proposed in PTL 1, in the use under a molten salt environment such as a heavy oil fired gas turbine, the dense layer containing silica as a main component on the outermost surface side prevents the penetration of the molten salt into the porous layer (thermal barrier layer) made of partially stabilized zirconia or the like, thereby preventing peeling of the thermal barrier coating to exhibit high durability.

On the other hand, in PTL 2, it is clarified that zirconia partially stabilized by ytterbium oxide (ytterbia; Yb₂O₃) (ytterbia partially stabilized zirconia; hereinafter, there is case where it is referred to as “YbSZ”) exhibits high thermal cycle durability due to high high-temperature crystal stability thereof under a normal gas-fired gas turbine environment, that is, an environment in which sulfate is not present. Further, it is stated that in the case of gas firing, high thermal cycle durability is exhibited by making the porosity of the film be in a range of 8 to 15%.

Further, in PTL 3, it is stated that in a ceramic thermal barrier coating, thermal spray powder particles which have a particle size distribution in which the size of the powder particle, in particular, a particle diameter in a cumulative particle size of 10% is 30 μm or more and 100 μm or less, and the maximum particle diameter of 150 μm or less, and contains particles having a particle diameter of 30 μm at a ratio of 3% or less and particles having a particle diameter of 40 μm at a ratio of 8% or less are used as thermal spray powder such as YbSZ, and defects in the film are greatly reduced due to such a particle size distribution to exhibits high thermal cycle durability.

### CITATION LIST

### Patent Literature

[PTL 1] Japanese Unexamined Patent Application, First Publication No. 2011-167994

[PTL 2] Japanese Patent No. 4388466

[PTL 3] Japanese Patent No. 5602156

[PTL 4] Japanese Patent No. 4969094

[PTL 5] Japanese Unexamined Patent Application, First Publication No. 2017-116272

### DISCLOSURE OF INVENTION

### Technical Problem

In the technique proposed in PTL 1, in forming the thermal barrier coating film, not only the formation of the porous layer (thermal barrier layer) by thermal spraying of partially stabilized zirconia or the like, but also the formation of the dense layer containing silica as a main component and containing ceramic fibers and the impregnation of the porous layer with the silica of the dense layer should be performed, and therefore, there are problems in which the process is complicated, the number of processes is increased, the productivity is inferior, and the cost is increased.

Further, the proposals of PTL 2 and PTL 3 have merely taken the case of gas firing into consideration and did not consider a turbine using low-quality fuel, such as a heavy oil fired turbine. In the case of the low-quality fuel, such as heavy oil firing, there is a phenomenon that a molten salt penetrates into the film to weaken the ceramic film, and therefore, in the techniques proposed in PTL 2 and PTL 3, it is thought that it is difficult to reliably improve the durability.

Therefore, the present invention has an object to provide a thermal barrier coating which exhibits high durability and can be efficiently formed at low cost.

### Solution to Problem

In order to solve the problems described above, the present invention provides the following aspects (1) to (6).

(1) A thermal barrier coating film including a ceramic material thermally sprayed and formed on a base material made of a heat resistant alloy constituting a turbine member in a gas turbine engine using low-quality fuel, in which ytterbia partially stabilized zirconia is used as the ceramic material of the thermal barrier coating film and a porosity of the film is 5% or more and less than 8%.

(2) The thermal barrier coating film according to the above (1), in which the porosity is in a range of 5% to 6%.

(3) The thermal barrier coating film according to the above (1) or (2), in which thermal spray powder which has a particle size distribution in which a 10% particle diameter in a cumulative particle size distribution is 30 μm or more and 100 μm or less, is used as ceramic spray powder for film formation, the thermal spray powder has a maximum particle diameter of 150 μm or less, and the thermal spray powder contains particles having a particle diameter of 30 μm at a ratio of 3% or less and particles having a particle diameter of 40 μm at a ratio of 8% or less.

(4) A turbine member including the thermal barrier coating film according to any one of the above (1) to (3) formed on a base material.

(5) The turbine member according to the above (4), in which the thermal barrier coating film is formed on a surface of the base material with a bonding layer interposed therebetween.

(6) The turbine member according to any one of the above (1) to (3), in which the turbine member is used in a heavy oil fired gas turbine.

### Advantageous Effects of Invention

The thermal barrier coating film according to the present invention can exhibit excellent durability and can be formed at low cost.

### BRIEF DESCRIPTION OF DRAWINGS

FIG. 1 is a schematic configuration diagram of a gas turbine in an embodiment of the present invention.

FIG. 2 is a perspective view showing a schematic configuration of a turbine blade in the embodiment of the present invention.

FIG. 3 is an enlarged sectional view of a main part of the turbine blade in the embodiment of the present invention.

FIG. 4 is a flowchart of a method of forming a thermal barrier coating film in the embodiment of the present invention.

FIG. 5 is a partial sectional perspective view of a test piece which is used in a molten salt penetration test in the embodiment of the present invention.

FIG. 6 is a partial sectional view showing a configuration of a molten salt penetration test apparatus which is applied in the embodiment of the present invention.

FIG. 7 is an enlarged sectional view of a support part main body in the molten salt penetration test apparatus.

FIG. 8 is an explanatory diagram of an accelerator and a salt supply part in the molten salt penetration test apparatus.

FIG. 9 is a flowchart of a molten salt penetration test method.

FIG. 10 is a partial sectional view showing a configuration of a thermal cycle test apparatus which is applied in the embodiment of the present invention.

FIG. 11 is a graph schematically showing a temperature change of a sample provided to a thermal cycle test by the apparatus shown in FIG. 10.

FIG. 12 is a diagram showing temperature measurement points of the sample provided to the thermal cycle test of FIG. 10.

FIG. 13 is a graph showing a relationship between a spray distance in an experimental example and durability in the thermal cycle test.

FIG. 14 is a graph showing a relationship between a film porosity in the experimental example and durability in the thermal cycle test.

FIG. 15 is a photograph showing an example of an optical micrograph of a film cross section in calculating the porosity of the film.

FIG. 16 is a photograph showing an example of an image obtained by binarizing the optical micrograph of the film cross section in calculating the porosity of the film.

### BEST MODE FOR CARRYING OUT THE INVENTION

Hereinafter, a thermal barrier coating film and a turbine member according to an embodiment of the present invention will be described based on the drawings. In the drawings which are used in the following description, there is a case where in order to make the features easy to understand, for the sake of convenience, portions for the features are shown in an enlarged manner, and a dimensional ratio or the like of each constituent element is not necessarily the same as the actual dimensional ratio or the like. Further, materials, dimensions, and the like exemplified in the following description are merely examples, and the present invention is not limited thereto and can be appropriately changed and implemented within a scope which does not change the gist of the invention.

<Configuration of Turbine>

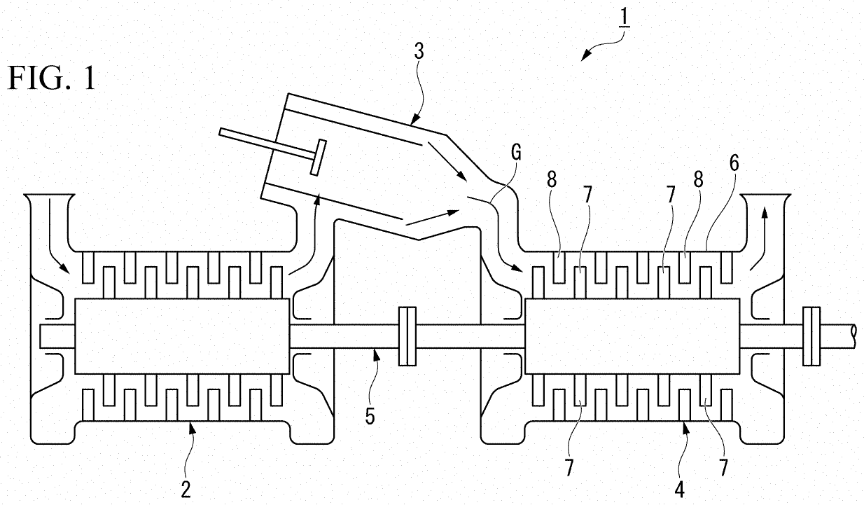

FIG. 1 is a schematic configuration diagram of a gas turbine in an embodiment of the present invention.

As shown in FIG. 1, a gas turbine 1 in this embodiment includes a compressor 2, a combustor 3, a turbine main body 4, and a rotor 5.

The compressor 2 takes a large amount of air in the interior thereof and compresses it.

The combustor 3 mixes fuel with compressed air A compressed in the compressor 2 and burns the mixture.

The turbine main body 4 converts the thermal energy of a combustion gas G introduced from the combustor 3 into rotational energy. The turbine main body 4 blows the combustion gas G on a turbine blade 7 provided on the rotor 5 to convert the thermal energy of the combustion gas G into mechanical rotational energy, thereby generating power. In the turbine main body 4, in addition to a plurality of turbine blades 7 on the rotor 5 side, a plurality of turbine vanes 8 are provided at a casing 6 of the turbine main body 4. In the turbine main body 4, the turbine blades 7 and the turbine vanes 8 are alternately arranged in an axial direction of the rotor 5.

The rotor 5 transmits a part of the rotating power of the turbine main body 4 to the compressor 2 to rotate the compressor 2.

Hereinafter, in this embodiment, the turbine blade 7 of the turbine main body 4 will be described as an example of the turbine member according to the present invention.

<Turbine Blade (Turbine Member) and Coating Film>

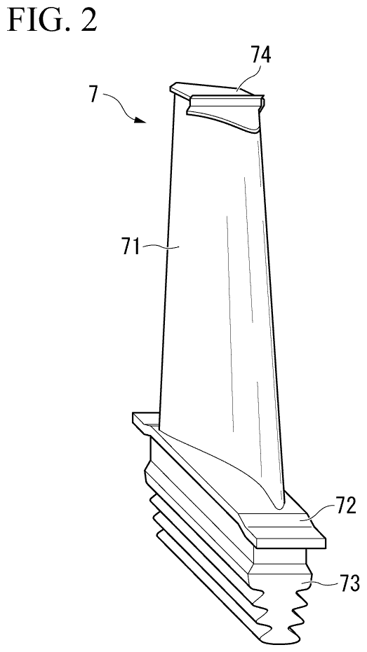

FIG. 2 is a perspective view showing a schematic configuration of the turbine blade in the embodiment of the present invention.

As shown in FIG. 2, the turbine blade 7 includes a turbine blade main body 71, a platform 72, a blade root 73, and a shroud 74. The turbine blade main body 71 is disposed in the flow path of the combustion gas G in the casing 6 of the turbine main body 4. The platform 72 is provided at a base end of the turbine blade main body 71. The platform 72 defines the flow path of the combustion gas G on the base end side of turbine blade main body 71. The blade root 73 is formed to protrude from the platform 72 to the side opposite to the turbine blade main body 71. The shroud 74 is provided at the tip of the turbine blade main body 71. The shroud 74 defines the flow path of the combustion gas G on the tip side of the turbine blade main body 71.

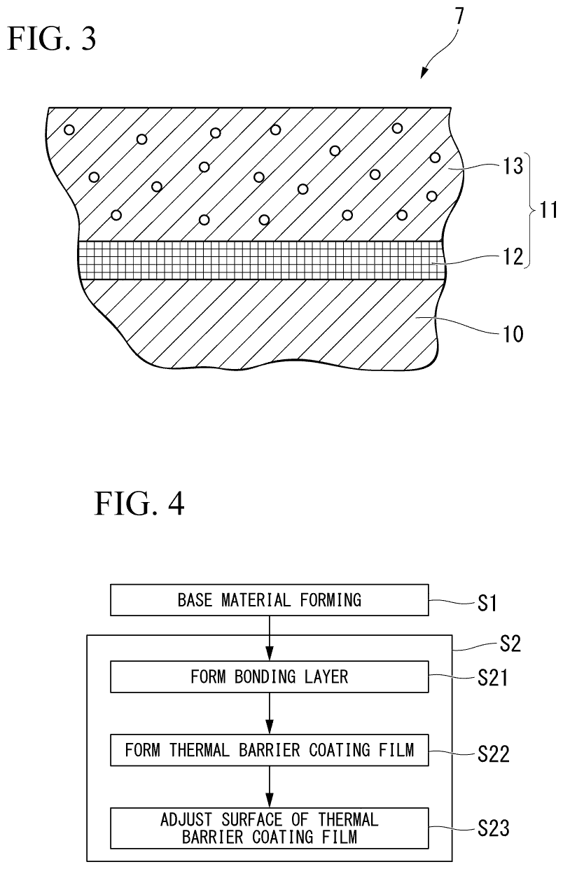

FIG. 3 is an enlarged sectional view of a main part of the turbine blade in the embodiment of the present invention.

As shown in FIG. 3, the turbine blade 7 is composed of a base material 10 and a coating layer 11.

The base material 10 is made of a heat resistant alloy such as a Ni-based alloy.

The coating layer 11 is formed so as to cover the surface of the base material 10. The coating layer 11 includes a bonding layer 12 and a thermal barrier coating film 13.

The bonding layer 12 is for suppressing the peeling of the thermal barrier coating film 13 from the base material 10 and is made of metal in which bonding strength to the base material 10 and the thermal barrier coating film 13 is high and corrosion resistance and oxidation resistance are excellent. The material of the bonding layer 12 and a method of forming the bonding layer 12 are not particularly limited. However, generally, for example, it is preferable that the bonding layer 12 is formed by thermally spraying metal spray powder of a MCrALY alloy as a thermal spray material on the surface of the base material 10. Here, “M” of the above MCrAlY alloy configuring the bonding layer 12 indicates a metal element. The metal element “M” is, for example, a single metal element such as NiCo, Ni, or Co, or a combination of two or more types of them.

The thermal barrier coating film 13 is laminated on the surface of the bonding layer 12. The thermal barrier coating film 13 is formed by thermally spraying a thermal spray material containing ceramic on the surface of the bonding layer 12. However, in the present invention, in particular, as the ceramic, ytterbia stabilized zirconia (YbSZ) which is zirconia (ZrO₂) partially stabilized with ytterbium oxide (Yb₂O₃; ytterbia) is used. Further, the thermal barrier coating film 13 is formed such that the porosity (pore occupancy per unit volume; vol %) thereof is 5% or more and less than 8% and more preferably 5% or more and less than 6%.

In this manner, in this embodiment, by using the ytterbia stabilized zirconia (YbSZ) as the ceramic material of the thermal barrier coating film 13 and setting the porosity thereof to be within a specific range, it has become possible to exhibit high durability as a turbine member using low-quality fuel, of a heavy oil fired boiler or the like. This is due to the following novel findings of the inventors of the present invention.

In a gas turbine using low-quality fuel such as heavy oil, a thermal barrier coating is exposed to a molten salt containing sodium sulfate which is generated by sodium, sulfur, or the like contained in the heavy oil, and the molten salt penetrates into the thermal barrier coating, and thus there is a concern that the thermal barrier coating may be damaged by the penetrated molten salt. Several mechanisms are considered with respect to the damage of the ceramic coating by the molten salt. For example, many mechanisms are considered, such as material deterioration due to the chemical reaction between YSZ and a molten salt (Na₂SO₄ or the like) in a case of using conventional general YSZ as a coating material, or an increase in thermal stress due to an increase in the elastic modulus of the film due to blockage of pores by the molten salt, and weakening of a coating due to crystal growth of the molten salt in pores. However, at present, the mechanisms are not necessarily clarified. In any case, the penetration of the molten salt into the ceramic coating decreases the durability of the film, and therefore, it has been strongly desired to develop a thermal barrier coating having high durability even if it is used under an environment in which a molten salt is present, such as a gas turbine using low-quality fuel such as heavy oil.

On the other hand, the inventors of the present invention have developed an apparatus and method for evaluating the durability of a thermal barrier coating film under a molten salt environment which simulates a use environment in a heavy oil fired gas turbine, and have already filed a patent application relating to a “molten salt penetration test apparatus and a molten salt penetration test method” which are described in PTL 5.

According to the molten salt penetration test method of PTL 5 described above, it is possible to evaluate the degree of the penetration of the molten salt into the thermal barrier coating film under the molten salt environment. Therefore, it is possible to simulate the penetration of the molten salt during use into the thermal barrier coating film on the surface of a turbine member such as a turbine blade or a turbine vane in a heavy oil fired gas turbine. Then, if a thermal cycle test is performed on the thermal barrier coating film into which the molten salt is penetrated, by such a molten salt penetration test method, it has become possible to evaluate the durability of the thermal barrier coating film during use in the heavy oil fired gas turbine.

Then, the inventors of the present invention have investigated the relationship between the type of the ceramic material of the thermal barrier coating film and the porosity thereof, and the result of durability evaluation by the molten salt penetration test method and the thermal cycle test as described above, and as a result, have newly found that due to using the ytterbia stabilized zirconia (YbSZ) as a ceramic and setting the porosity of the film to be 5% or more and less than 8%, the durability under the molten salt environment is surely superior to that of a porous thermal barrier coating film having a porosity of about 10%, which is made of yttria partially stabilized zirconia (YSZ) which has been commonly used in the past.

Using YbSZ instead of YSZ as the ceramic material of the thermal barrier coating film in the turbine member itself has been already considered in a part, as shown in, for example, PTL2 to PTL 4. However, the use of YbSZ under the molten salt environment has not been fully studied so far. That is, it became possible to first reproduce the penetration of the molten salt into the thermal barrier coating film under the molten salt environment by the molten salt penetration test apparatus and test method shown in PTL 5 developed by the inventors of the present invention, as described above, and evaluate the durability of the thermal barrier coating film under the molten salt environment. However, at the point in time before the development of the molten salt penetration test apparatus and test method described above, it is difficult to correctly evaluate the durability under the molten salt environment, and therefore, even if YbSZ was used under the molten salt environment, the durability thereof could not be grasped correctly.

However, due to the development of the new molten salt penetration test apparatus and test method shown in PTL 5, it became possible to evaluate the durability of the thermal barrier coating film in a case of being used in a heavy oil fired gas turbine (and therefore, in a case of being used under the molten salt environment), and accordingly, the effectiveness of the use of YbSZ within a predetermined porosity range has been newly founded.

In the embodiment of the present invention, when the porosity of the thermal barrier coating film 13 made of YbSZ is less than 5%, thermal conductivity becomes high, and thus it becomes difficult to sufficiently exhibit a heat shielding effect with respect to the base material 10. On the other hand, if the porosity is 8% or more, it becomes difficult to sufficiently secure the durability in the use under the molten salt environment. That is, even in the thermal barrier coating film 13 made of YbSZ, if the porosity thereof is 8% or more, it cannot be said that the durability in the use under the molten salt environment is sufficiently excellent compared to a thermal barrier coating film (a conventional material) having a porosity of about 10%, which is made of general YSZ in the related art.

In this manner, the influence of the porosity of the thermal barrier coating film 13 made of YbSZ on the durability in the use under the molten salt environment has been found by the detailed experiments by the inventors of the present invention, as will be described in detail later according to an experimental example.

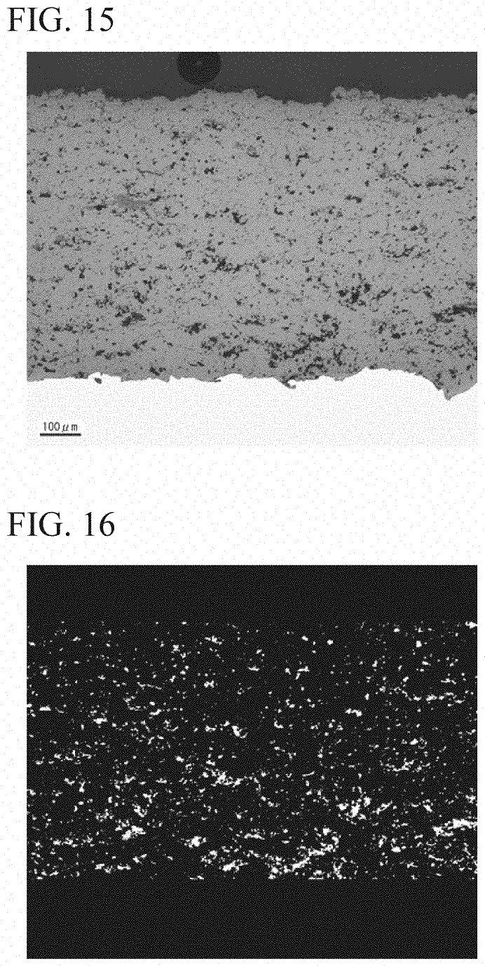

A method of measuring the porosity of the thermal barrier coating film 13 is not particularly limited. However, for example, the cross section of the film 13 may be observed to measure the occupancy of a pore portion in the cross section. Specifically, for example, it is favorable if an optical micrograph (for example, FIG. 15) of the cross section in a thickness direction of the film is taken, the photograph is binarized into a white portion and a black portion by image processing, the area ratio of a portion (for example, a white portion) corresponding to a pore portion, in the obtained binarized image (for example, FIG. 16), is obtained, and the area ratio is taken as the porosity. In this case, the area ratio is calculated. However, since the area ratio of the pore portion is substantially equal to the volume ratio of the pore portion, the value of the above area ratio can be regarded as the porosity (vol %).

Further, preferred conditions other than the above for the coating layer 11 will be described.

The thickness of the bonding layer 12 is not particularly limited. However, in general, it is preferable that the thickness is in a range of about 0.01 mm to 1 mm, as shown in claim 4 of, for example, PTL 4.

Further, in general, it is preferable that the thickness of the thermal barrier coating film 13 is likewise in a range of about 0.01 mm to 1 mm, as shown in claim 4 of PTL 4. If the thickness is less than 0.01 mm, there is a concern that it may be difficult to sufficiently exhibit the heat shielding effect. On the other hand, if the thickness exceeds 1 mm, although the heat shielding properties become high, there is a concern that the durability may tend to decrease.

With respect to the composition of the thermal spray material when forming the thermal barrier coating film 13 by thermal spraying, it is preferable that the ytterbium oxide (Yb₂O₃) as a stabilizing material is in a range of 16 to 20% by weight, as shown in claim 6 of PTL 2, and the remainder is substantially zirconia (ZrO₂).

<Method of Forming Turbine Member>

Next, an example of a method of forming a turbine member in which the coating layer 11 described above is formed on the surface of the base material 10 will be described.

FIG. 4 is a flowchart of the method of forming a turbine in the embodiment of the present invention.

As shown in FIG. 4, first, as a base material forming step S1, the base material 10 is formed in the shape of a target turbine member, for example, the turbine blade 7. The base material 10 in this embodiment is formed using the Ni-based heat resistant alloy described above, or the like.

Subsequently, as a coating method S2, a bonding layer lamination (bonding coat layer formation) step S21, a thermal barrier coating film lamination (top coat layer formation) step S22, and a surface adjustment step S23 are sequentially performed.

In the bonding layer lamination step S21, the bonding layer (bonding coat layer) 12 is formed on the surface of the base material 10. In the bonding layer lamination step S21 of this embodiment, for example, metal spray powder such as a MCrAlY alloy is thermally sprayed on the surface of the base material 10 by a low-pressure plasma spraying method.

In the thermal barrier coating film lamination step S22, the thermal barrier coating film (top coat layer) 13 is laminated on the bonding layer 12. In the thermal barrier coating film lamination step S22 of this embodiment, for example, powder of YbSZ as described above is thermally sprayed on the bonding layer 12 as a thermal spray material by an atmospheric pressure plasma spraying method (APS; Atmospheric pressure Plasma Spray).

Here, in the thermal barrier coating film lamination step S22, the porosity of the thermal barrier coating film 13 is set to be 5% or more and less than 8% and more preferably, in a range of 5 to 6%. As a method of controlling the porosity of the thermal barrier coating film 13 in this manner, for example, a method of changing the distance(in other words, a spray distance) between the base material 10 and the tip (not shown) of a nozzle of a thermal spraying device for spraying the thermal spray material described above is typical. That is, if other spraying conditions are fixed, the shorter the spray distance, the smaller the porosity of the sprayed layer becomes, that is, the finer the porosity becomes. Therefore, it is favorable if the spray distance is set such that the porosity of the thermal barrier coating film 13 is 5% or more and less than 8% and more preferably, in a range of 5 to 6%. In addition, the porosity of the thermal barrier coating film 13 can also be made smaller by, for example, a method such as increasing a spray current of the thermal spraying device. Further, a desired porosity may be obtained by controlling both the spray distance and the spray current.

The surface adjustment step S23 adjusts the state of the surface of the coating layer 11. Specifically, in the surface adjustment step S23, the surface of the thermal barrier coating film 13 is slightly scraped to adjust the film thickness of the coating layer 11, or the surface is made smoother. For example, the heat transfer coefficient to the turbine blade 7 can be reduced by the surface adjustment step S23. In the surface adjustment step S23 of this embodiment, the thermal barrier coating film 13 is scraped by several tens of micrometers to make the surface smooth and adjust the film thickness.

It is preferable that as the particle size distribution of the thermal spray powder when forming the thermal barrier coating film (top coat layer) 13 by thermally spraying powder made of YbSZ, the thermal spray powder has a particle size distribution in which a particle diameter in a cumulative particle size of 10% is 30 μm or more and 100 μm or less, as described in PTL 3, and the maximum particle diameter is 150 μm or less, and the thermal spray powder contains particles having a particle diameter of 30 μm at a ratio of 3% or less and particles having a particle diameter of 40 μm at a ratio of 8% or less. By not only making the porosity of the film 5% or more and less than 8% but also adjusting the particle size distribution of the thermal spray powder, as described above, it becomes possible to more reliably improve the thermal cycle durability.

Further, the thermal barrier coating film according to the present invention is formed on a turbine member configuring a gas turbine engine using low-quality fuel. Here, typical low-quality fuel is Grade 1 (A-type heavy oil) specified by JIS 2205. However, a case of using other low-quality fuel, for example, Grade 2 (B-type heavy oil) or Grade 3 (C-type heavy oil) similarly specified by JIS 2205, or heavy oil fuel equivalent thereto, for example, crude oil called ASL (Arab Super Light) or AXL (Arab Extra Light) is also effective. With respect to these, according to “Latest Developments of Siemens Heavy Duty Gas Turbines for the Saudi Arabian Market” publicly disclosed on the website of the following URL of Siemens, Rabigh II crude oil of ASL contains about 2.1 ppm of Na+K, about 0.5 ppm of V, and about 0.1 wt % of S, and the gas turbine manufacturer also needs consideration in a case where these components are excessively large in a case of using such crude oil. Further, the thermal barrier coating film according to the present invention is not limited to oil fuel and is also effective in a case of using coal gasification fuel as low-quality fuel.

[http://www.energy.siemens.com/hq/pool/hq/energy-topics/pdfs/en/techninal %20paper/Siemens-Technical %20Paper-Latest-Developments-for-Saudi-Arabian-Market.pdf]

Next, an experimental example performed by the inventors of the present invention will be described.

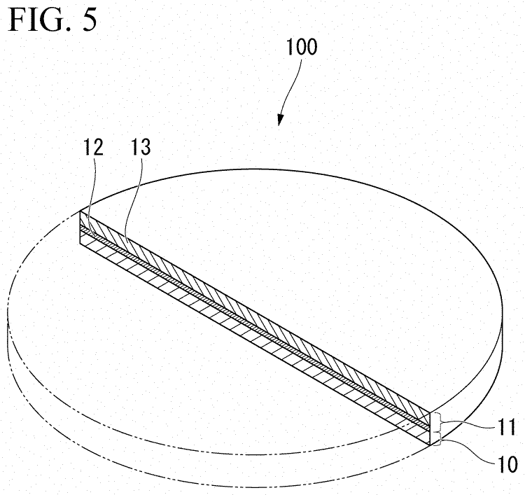

In the following experiment, a molten salt penetration experiment was performed using a molten salt penetration test apparatus developed by the inventors of the present invention, and further, a laser thermal cycle test was performed on a test piece after the molten salt penetration experiment. Therefore, first, the molten salt penetration test apparatus and the molten salt penetration experiment using the apparatus will be described with reference to FIGS. 5 to 9.

<Molten Salt Penetration Test>

FIG. 5 is a partial sectional perspective view of a test piece 100 provided to the molten salt penetration test.

As shown in FIG. 5, the test piece 100 is formed to simulate the surface of a turbine blade of a gas turbine. The test piece 100 is composed of the base material 10 and the coating layer 11 on the base material 10, and the coating layer 11 is composed of the bonding layer 12 on the base material side, and the thermal barrier coating film 13 on the surface side. Further, the test piece 100 is formed in a disk shape.

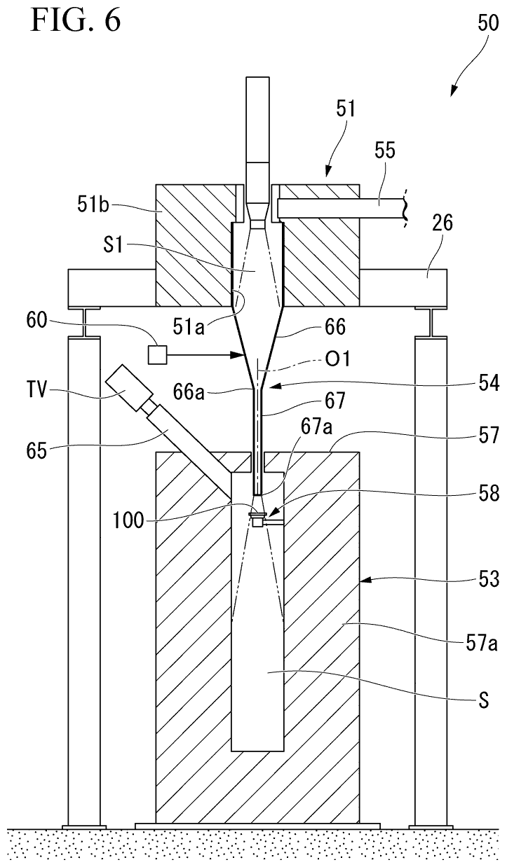

FIG. 6 is partial sectional view showing the configuration of the molten salt penetration test apparatus in this example.

As shown in FIG. 6, a molten salt penetration test apparatus 50 includes a combustor 51, an accommodation support part 53, an accelerator 54, and a salt supply part 60. The molten salt penetration test apparatus 50 is an apparatus for causing a combustion gas containing a molten salt to collide with the test piece 100 described above. A user can evaluate the penetration state of the molten salt of the coating layer 11 by observing the test piece 100 tested by the molten salt penetration test apparatus 50. Here, with respect to the coating layer 11, for example, deterioration of the coating layer 11 can be determined by evaluating the penetration state of the molten salt.

The combustor 51 mixes fuel with the compressed air compressed in a compressor (not shown) and burns the mixture. The combustor 51 includes an air supply part 55 capable of supplying compressed air from the outside to the combustion gas G. The air supply part 55 is made to be able to finely adjust the amount of air which is supplied to the combustion gas G by an electromagnetic valve or the like. According to the air supply part 55, the temperature of the combustion gas G can be reduced, for example, by increasing the amount of air which is supplied to the combustion gas G.

The combustor 51 is disposed above the accommodation support part 53 by a stand 56. The combustor 51 is mounted to the stand 56 such that an injection port 51a is directed downward so that the combustion gas G is directed vertically downward. The combustor 51 includes a container 51b having excellent heat insulating properties and suppresses the thermal energy of the combustion gas G from being released to the outside through the container 51b.

The accommodation support part 53 accommodates the test piece 100 having the surface covered with the coating layer 11 in a state of being supported from below. The accommodation support part 53 includes a chamber 57 and a support part main body 58.

The chamber 57 includes an accommodation space S for accommodating the test piece 100 in the interior thereof. Each of the wall portions 59 configuring the chamber 57 is also formed using a material having excellent heat insulating properties, similarly to the container 51b of the combustor 51 described above. That is, the chamber 57 can keep the accommodation space S warm due to the heat insulating properties of the wall portion 59. Each of the wall portion 59 and the container 51b is formed by a heat insulating material itself or formed by mounting a heat insulating material to a frame (not shown).

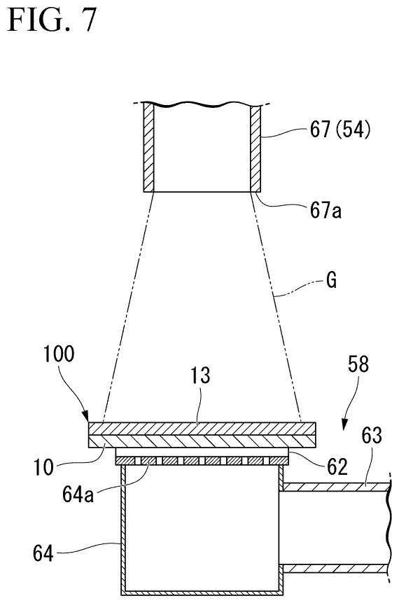

FIG. 7 is an enlarged sectional view of the support part main body in the embodiment of the present invention.

As shown in FIGS. 6 and 7, the support part main body 58 supports the test piece 100 from below and cools the base material 10 exposed on the back surface side of the test piece 100. The support part main body 58 includes a cooling air supply part 61 and a support ring part 62.

The cooling air supply part 61 blows cooling air which is supplied from the outside against the base material 100. The cooling air supply part 61 includes an air supply pipe 63 and a box body 64.

The air supply pipe 63 is formed in a tubular shape penetrating a side wall 57a (refer to FIG. 6) of the chamber 57 and extending toward the center in the horizontal direction of the accommodation space S. The cooling air supplied from the outside flows toward the center of the accommodation space S through the interior of the air supply pipe 63. An end portion of the air supply pipe 63 is connected to the side wall of the box body 64.

The box body 64 has a function of changing the flow direction of the cooling air supplied by the air supply pipe 63 so as to be directed upward to the back surface of the test piece 100. In the box body 64 in this embodiment, only an upper wall 64a is formed of punching metal, mesh, or the like, which has a plurality of holes. Due to the upper wall 64a, the cooling air flowing into the box body 64 from the air supply pipe 63 is ejected upward through the holes of the upper wall 64a.

The support ring part 62 is formed in an annular shape protruding upward from an upper wall peripheral edge of the box body 64 of the cooling air supply part 61. The test piece 100 is held by the support ring part 62. As a method of holding the test piece 100, bolting, welding, or the like can be given as an example. In this way, the test piece 100 is separated from the upper wall 64a of the box body 64 by a predetermined distance and is supported from below by the support ring part 62 in a posture parallel to the upper wall 64a. Here, the cooling air supply part 61 may have a temperature detection unit such as a thermocouple in a flow path through which the cooling air flows. In this way, the temperature distribution in the thickness direction of the test piece 100 can be controlled by adjusting the flow rate of the cooling air according to the temperature of the cooling air detected by the temperature detection unit.

The air supply pipe 63, the box body 64, and the support ring part 62 configuring the support part main body 58 described above have not only a function as a pipeline for supplying the cooling air but also a function as a cantilever beam for supporting the test piece 100 from below.

The accommodation support part 53 is provided with an observation window part 65. The observation window part 65 communicates with the accommodation space S accommodating the test piece 100 from the outside. The observation window part 65 extends in a radial direction with the test piece 100 supported by the support part main body 58 as the center. A thermos viewer TV capable of detecting the temperature distribution of the test piece 100 is mounted to the observation window part 65 in this embodiment. In this embodiment, a case where only one observation window part 65 is formed in the accommodation support part 53 is illustrated. However, a plurality of observation window parts 65 may be formed in the accommodation support part 53. Further, an observation device other than the thermos viewer may be mounted to the observation window part 65 described above.

Although not shown in FIG. 7 for convenience of illustration, the support ring part 62 described above is provided with, for example, a cutout (not shown) such that the cooling air colliding with the back surface of the test piece 100 can be discharged to the accommodation space S. Further, the accommodation support part 53 is provided with a discharge mechanism (not shown) for discharging the combustion gas G blown against the test piece 100. Due to the discharge mechanism, the combustion gas G blown against the test piece 100 is suctioned by the discharge mechanism and discharged to the outside of the chamber 57.

The accelerator 54 accelerates the flow velocity of the combustion gas G containing the molten salt to cause the combustion gas G to collide with the test piece 100.

As shown in FIG. 6, the accelerator 54 is provided with a throttling portion 66 and a straight pipe portion 67.

The throttling portion 66 is connected to the combustor 51 at an end portion on the upstream side in the flow direction of the combustion gas G. The throttling portion 66 is formed in a tubular shape in which a flow path cross-sectional area gradually decreases toward the downstream side in the flow direction of the combustion gas G. The throttling portion 66 in this embodiment has a flow path cross-sectional area reduced at a constant inclination angle. The throttling portion 66 may have, for example, a double structure including an inner wall and an outer wall such that cooling air for suppressing overheating of the throttling portion 66 flows through the space between the inner wall and the outer wall.

The straight pipe portion 67 is formed in a straight pipe shape having a constant flow path cross-sectional area. The straight pipe portion 67 connects a downstream-side end portion 66a of the throttling portion 66 and the accommodation support part 53. More specifically, the straight pipe portion 67 extends from the downstream-side end portion 66a of the throttling portion 66 to the interior of the accommodation space S of the accommodation support part 53. A downstream-side end portion 67a of the straight pipe portion 67 is disposed at a position immediately above the test piece 100. The straight pipe portion 67 is disposed such that an axis O1 thereof is orthogonal to the surface of the test piece 100 accommodated in the interior of the accommodation support part 53. That is, the accelerator 54 causes an internal space S1 of the combustor 51 to communicate with the accommodation space S of the accommodation support part 53.

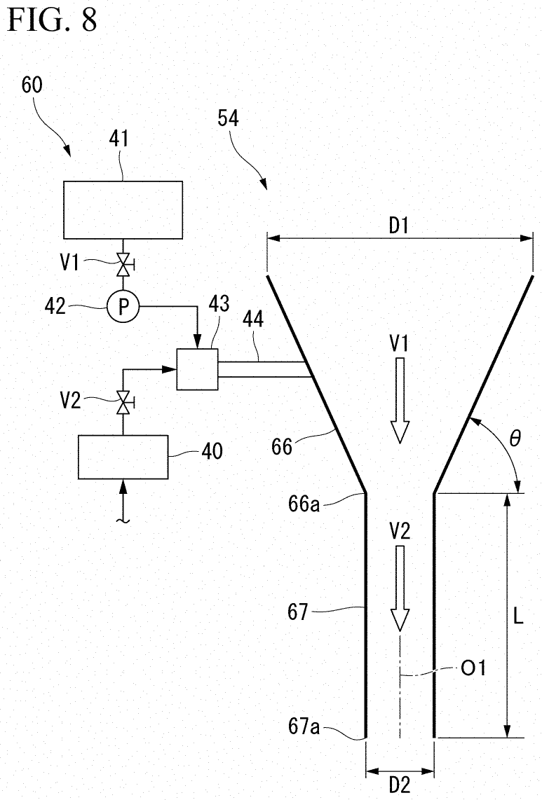

FIG. 8 is an explanatory diagram of the accelerator and the salt supply part in the molten salt penetration test apparatus of this example.

As shown in FIG. 8, an inclination angle θ of the throttling portion 66 in this embodiment is formed at an angle necessary for the acceleration of the combustion gas G. Here, the inclination angle θ is an angle with respect to the horizontal plane perpendicular to the axis O1.

An inner diameter D2 of the straight pipe portion 67 is set to a size in which the flow velocity at the outlet of the straight pipe portion 67 becomes lower than the sound speed, based on the amount of combustion gas G of the combustor 51. For example, when the amount of combustion gas G when the load of the combustor 51 is 100% is “Q” (m³/s) and the sound speed of the combustion gas G is “Vc” (m/s), the inner diameter D2 can be determined by the following expression (1).

D2=(Q/Vc×4/π)^{0.5} (1)

The straight pipe portion 67 is formed to have such a length L that the flow velocity of the combustion gas G (hereinafter, referred to as a gas flow velocity) reaches a target value.

When the gas flow velocity in the throttling portion 66 is “V1” and the gas flow velocity in the straight pipe portion 67 is “V2”, the following expression (2) is established.

V1/V2=D2/D1 (2)

The salt supply part 60 supplies a salt to the combustion gas G. The salt supplied to the combustion gas G melts into a molten salt and further evaporates to change into a gaseous state. The molten salt which has changed into a gaseous state penetrates from the surface of the test piece 100, that is, the thermal barrier coating film 13 toward the bonding layer 12.

The salt supply part 60 includes a compressor 40, a solution tank 41, a metering pump 42, a two-fluid nozzle (supply nozzle) 43, and a supply pipe 44.

The compressor 40 supplies compressed air toward the two-fluid nozzle 43 at a constant pressure. The compressor 40 may be shared with a compressor which supplies cooling air to the throttling portion 36 described above.

The solution tank 41 stores an aqueous solution of the salt. The solution tank 41 in this embodiment stores, for example, an aqueous solution of sodium sulfate (Na₂SO₄). Here, the salt concentration of the aqueous solution which is stored in the solution tank 41 can be set to be in a range of 0.1% by mass to 0.5% by mass, and further, in a range of 0.25% by mass to 0.35% by mass. In this embodiment, an aqueous solution containing sodium sulfate in the amount of 0.3% by mass is used.

The metering pump 42 supplies the aqueous solution stored in the solution tank 41 toward the two-fluid nozzle 43 at a constant volumetric flow rate. Here, the volumetric flow rate of the aqueous solution which is supplied toward the two-fluid nozzle 43 by the metering pump 42 can be set to b in a range of 0.5 (L/h) to 0.7 (L/h). In this embodiment, the aqueous solution is supplied to the two-fluid nozzle 43 at 0.6 (L/h).

The two-fluid nozzle 43 atomizes the aqueous solution supplied from the solution tank 41 into, for example, a mist by using the compressed air supplied from the compressor 40. Here, as the two-fluid nozzle 43, various types of two-fluid nozzles, such as an internal mixing type, an external mixing type, and a collision type can be adopted. Here, in this embodiment, a case of adopting a pressurization type of supplying the aqueous solution in the solution tank 41 by the metering pump 42 has been described. However, a so-called suction-type two-fluid nozzle 43 may be adopted in which the aqueous solution is sucked up and sprayed by the force of compressed air.

The supply pipe 44 supplies the aqueous solution atomized by the two-fluid nozzle 43 to the interior of the accelerator 24. The supply pipe 44 in this embodiment is connected to the accelerator 24, and therefore, for example, a ceramic pipe may be used from the viewpoint of heat resistance. The inner diameter of the supply pipe 44 can be set to be in a range of 5 mm to 7 mm. The inner diameter of the supply pipe 44 in this embodiment is in a range of 5.5 mm to 6.5 mm (for example, 6.0 mm).

The salt supply part 60 includes a valve V1 between the metering pump 42 and the solution tank 41.

Similarly, the salt supply part 60 includes a valve V2 between the compressor 40 and the two-fluid nozzle 43. The valve V1 is opened when supplying the aqueous solution to the two-fluid nozzle 43 and is closed otherwise. On the other hand, the valve V2 is always opened and is closed, for example, at the time of maintenance or the like.

<Molten Salt Penetration Test Method>

Next, a molten salt penetration test method by the molten salt penetration test apparatus 50 described above will be described.

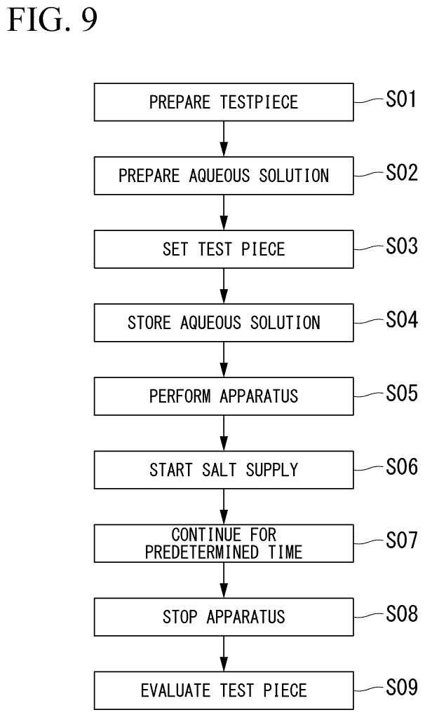

FIG. 9 is a flowchart of the molten salt penetration test method in this example. As shown in FIG. 9, first, the test piece 100 having the coating layer 11 on the surface of the base material 10 is prepared (step S01), and an aqueous solution of a salt is prepared (step S02).

Thereafter, the test piece 100 is set on the support part main body 58 (step S03), and the aqueous solution is stored in the solution tank 41 (step S04). The salt and water may be mixed in the solution tank 41 to prepare an aqueous solution. Step S01 and step S02 may be performed in reverse order or may be performed simultaneously. Similarly, step S04 and step S05 may be performed in reverse order or may be performed simultaneously.

Subsequently, the molten salt penetration test apparatus 50 is started.

Then, the compressed air and fuel are burned in a mixed state in the combustor 51 to generate a high-temperature combustion gas G. Further, compressed air is supplied to the high-temperature combustion gas G through the air supply part 55 to perform temperature adjustment.

On the other hand, cooling air is blown against the test piece 100 disposed in the accommodation space S of the accommodation support part 53 from the back surface by the cooling air supply part 61. In this way, the cooling of the base material 10 is continued.

Further, the valves V1 and V2 of the salt supply part 60 are opened, and thus the supply of the atomized aqueous solution to the accelerator 54 is started (step S06). Then, the salt contained in the aqueous solution is heated by the combustion gas G to become a molten salt, and the molten salt is further gasified. Here, the water contained in the aqueous solution is heated and evaporated.

The combustion gas G containing a fixed amount of the gasified molten salt is accelerated to a flow velocity which is a target velocity by the accelerator 54. The combustion gas G accelerated to the target velocity collides with the coating layer 11, more specifically, the thermal barrier coating film 13 of the test piece 100 held in the accommodation space S through the accelerator 54. At this time, the temperature distribution of the test piece 100 is monitored by the user through the thermos viewer TV, and the temperature adjustment of the combustion gas G and the temperature adjustment of the test piece 100 by the cooling air are performed such that the temperature distribution equivalent to that in the actual machine is obtained.

After this state is continued for a predetermined time (step S07), the user stops the molten salt penetration test apparatus 50 (step S08), takes the test piece 100 out of the accommodation support part 53, and evaluates the penetration state or the like of the molten salt of the thermal barrier coating film 13 (step S09),

Therefore, according to the example described above, the combustion gas G of the combustor 51 can be used as a carrier gas of the salt. For this reason, the temperature of the test piece 100 can be increased to a temperature equivalent to that of the turbine member of the actual machine. Further, the combustion gas G containing the salt can be made to collide with the test piece 100 after it is accelerated by the accelerator 54. In this way, the flow velocity of the combustion gas G containing the salt can be increased to the flow velocity equivalent to that of the combustion gas of the actual machine while using the small-sized combustor 51. That is, the boundary condition of the coating layer 11 of the test piece 100 can be made equivalent to the boundary condition of a thermal barrier coating in the real machine. As a result, it becomes possible to correctly evaluate the penetration state of the molten salt to the coating layer 11 of the test piece 100 while suppressing an increase in the size of the apparatus.

Further, the two-fluid nozzle 43 is provided, whereby the molten salt can be more uniformly mixed with the combustion gas G. For this reason, it is possible to reproduce the combustion gas G in the state equivalent to that in the actual machine.

Further, the cooling air supply part 61 is provided, whereby it is possible to cool the base material 10 of the test piece 100 coated with the coating layer 11. For this reason, it is possible to cause the temperature distribution equivalent to the temperature distribution in the thickness direction of the turbine member of the actual machine to appear in the test piece 100 as well. As a result, it is possible to more accurately evaluate the penetration state of the molten salt to the coating layer 11 of the test piece 100.

Further, in the accelerator 54, the flow path cross-sectional area of the throttling portion 66 gradually decreases, whereby it is possible to smoothly increase the flow velocity of the combustion gas. Further, the straight pipe portion 67 is provided, whereby the combustion gas G whose flow velocity has been increased by the throttling portion 66 is rectified, so that the combustion gas G can be further accelerated. As a result, it is possible to cause the combustion gas G containing the molten salt to efficiently collide with the test piece 100 while sufficiently increasing the flow velocity of the combustion gas G.

Further, it is possible to reduce the temperature of the combustion gas G by supplying air for temperature adjustment to the combustion gas G. For this reason, the temperature of the coating layer 11 of the test piece 100 can be easily adjusted to a desired temperature by increasing or decreasing the supply amount of the air for temperature adjustment.

Further, it is possible to observe the state of the test piece 100 during the erosion test through the observation window part 65. For this reason, it is possible to suppress the occurrence of deviation between the boundary condition of the test piece 100 and the boundary condition of the actual machine.

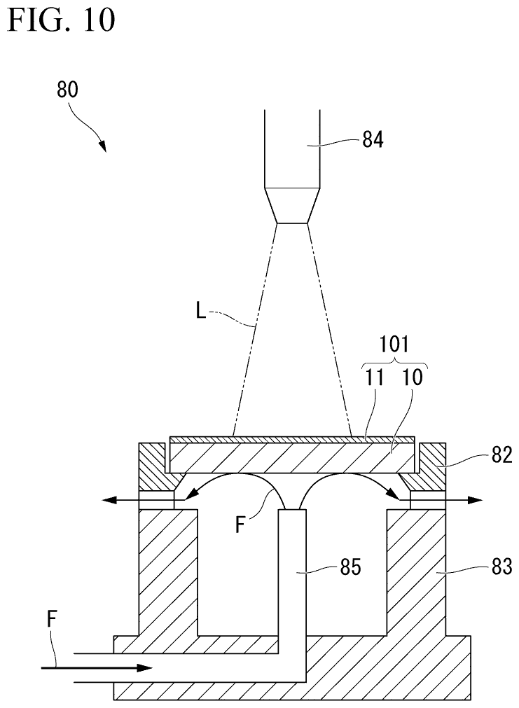

Next, since a laser thermal cycle test is performed on the test piece after the molten salt penetration test is performed using the molten salt penetration test apparatus described above, a laser thermal cycle test apparatus will be described with reference to FIG. 10.

<Thermal Cycle Test Apparatus>

FIG. 10 is a partial sectional view showing the configuration of the thermal cycle test apparatus.

As shown in FIG. 10, a thermal cycle test apparatus 80 is made so as to dispose a sample 101 having the coating layer 11 formed on the base material 10 at a sample holder 82 disposed on a main body portion 83 such that the coating layer 11 is on the outside, and heat the sample 101 from the coating layer 11 side by irradiating the sample 101 with laser light L from a CO₂ laser device 84. Further, at the same time as the heating by the CO₂ laser device 84, the sample 101 is cooled from the back surface side thereof by a gas flow F which is discharged from the tip of a cooling gas nozzle 85 disposed to penetrate the main body portion 83 at a position facing the back surface side of the sample 101 in the interior of the main body portion 83.

According to such a thermal cycle test apparatus, it is possible to easily form a temperature gradient in the interior of the sample 101, and thus it is possible to perform evaluation in line with a use environment in a case of being applied to a high-temperature part such as a gas turbine member.

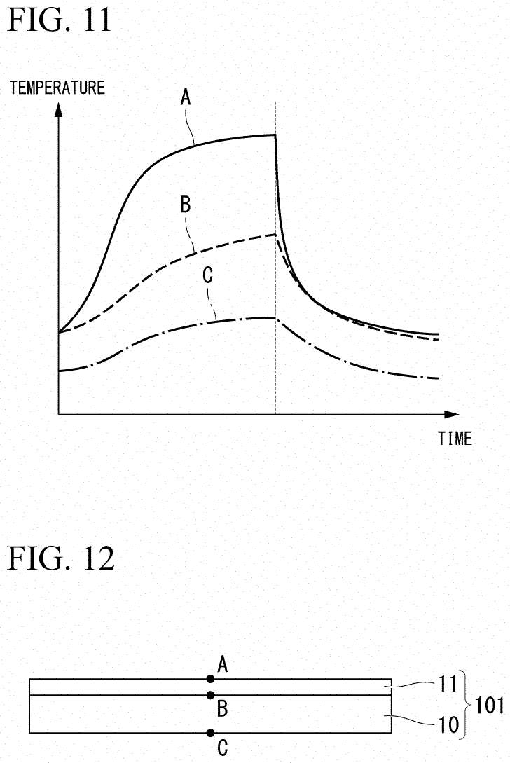

FIG. 11 is a graph schematically showing a temperature change of the sample provided to the thermal cycle test by the apparatus shown in FIG. 10. FIG. 12 is a diagram showing temperature measurement points of the sample provided to the thermal cycle test. Curves A to C shown in FIG. 11 respectively correspond to temperature measurement points A to C in the sample 101 shown in FIG. 10.

As shown in FIG. 11, according to the thermal cycle test apparatus shown in FIG. 10, it is possible to perform heating such that a temperature is lowered in order of the surface (A) of the coating layer 11 of the sample 101, the interface (B) between the coating layer 11 and the base material 10, and the back surface side (C) of the base material 10. For this reason, for example, by making the surface of the coating layer 11 have a high temperature of 1200° C. or more and making the temperature of the interface between the coating layer 11 and the base material 10 be in a range of 800 to 900° C., it is possible to obtain the same temperature condition as that in the actual machine gas turbine. The heating temperature and temperature gradient by this thermal cycle test apparatus can be easily made to desired temperature conditions by adjusting the output of the CO₂ laser device 84 and the gas flow F.

Hereinafter, an experimental example is shown in which a thermal barrier coating film is formed on a test piece by thermal spraying and the test piece is provided to the molten salt penetration test and the thermal cycle test.

### Experimental Example

The test piece 100 as shown in FIG. 5 was prepared as follows.

A bonding coat layer (bonding layer) made of a CoNiCrAlY alloy having a composition of Co-32Ni-21Cr-8A1-0.5Y shown in Example 1 of PTL 2 was formed in a thickness of 0.1 mm on the surface of the base material 10 made of a Ni-based alloy, by a low-pressure plasma spraying method.

Test pieces No. 1 to No. 3 was prepared by forming the top coat layer (thermal barrier coating film) 13 on the surface of the bonding layer 12 by thermally spraying YbSZ on the surface of the bonding layer 12 by an atmospheric pressure plasma spraying method, and forming the coating layer 11 in a total average thickness of 0.5 m.

At this time, the spray distance is set to be 1 on the basis of the spray distance in the case of normal YSZ, and in the case of YbSZ, three types of test pieces (No. 1 having a relative spray distance of 0.47, No. 2 having a relative spray distance of 0.80, and No. 3 having a relative spray distance of 1.20) were prepared by changing the ratio (relative spray distance) to the reference distance in three stages, 0.47, 0.80, and 1.20.

Further, for comparison, a conventional material test piece No. 4 in which the thermal barrier coating film 13 was formed by thermal spraying of YSZ was prepared. The spray distance at this time is 1, as described above as the reference of a relative distance.

In the preparation of the test pieces No. 1 to No. 3, as a YbSZ thermal spray material, a material in which ytterbia (Yb₂O₃) is 16% by weight and the remainder is substantially zirconia (ZrO₂), as shown in claim 1 of PTL 2 was used. Further, highly durable powder was used in which layered defects were able to be reduced by thermal spray film formation using powder in which a powder particle diameter has a particle size distribution in which a particle diameter in a cumulative particle size of 10% shown in PTL 3 is 30 μm or more and 100 μm or less, specifically, a particle diameter in a cumulative particle size of 10% is 45 μm, the maximum particle diameter is 150 μm or less, and the ratio of particles having a particle diameter of 40 μm is 8% or less.

On the other hand, as the thermal spray material of the conventional material test piece No. 4, a material was used in which yttria (Y₂O₃) which is generally commercially available is 8% by weight and the remainder is substantially zirconia (ZrO₂).

Each of the test pieces No. 1 to No. 4 was subjected to the molten salt penetration test according to the method shown in FIG. 9 using the molten salt penetration test apparatus shown in FIGS. 6 to 8. The test conditions are as follows.

Combustion gas temperature: 1500° C.

Combustion gas type: LPG gas

Combustion gas flow velocity: 300 m/s

TBC surface temperature: 1100° C.

Bonding coat temperature: 800° C.

Supplied molten salt: sodium sulfate (Na₂SO₄) aqueous solution

Supply concentration: mixed with pure water such that a concentration of 0.046% is obtained

Supply time: 8 h

These test conditions were in accordance with conditions, under which Na₂SO₄ sufficiently penetrates into the thermal barrier coating film using normal YSZ, confirmed by a preliminary test.

Further, each of the test pieces No. 1 to No. 4 after the molten salt penetration test was subjected to the thermal cycle test using the laser thermal cycle test apparatus shown in FIG. 10.

Then, a difference ΔT (=T1−T2) between a temperature T1 of the surface of the thermal barrier coating film 13 and a temperature T2 at the interface position between the thermal barrier coating film 13 and the bonding layer 12 was repeatedly applied to examine the durability of the thermal barrier coating film. Here, the value of the temperature difference ΔT described above is an index indicating the degree of durability in the thermal barrier coating film, and therefore, as the durability evaluation, the temperature difference ΔT (peeling limit temperature difference in TBC) of a limit at which peeling does not occur even after 1000 cycles was evaluated.

From the above experiment, it became clear that in No. 1 to No, 3 using YbSZ, the number of thermal cycles until film peeling is larger than that in No. 4 which is the conventional material using YSZ and from this, the durability under the molten salt environment is excellent. Further, it was confirmed that among No. 1 to No. 3 using YbSZ, in No. 1 having the spray distance of 70 mm and No. 2 having the spray distance of 120 mm, ΔT is larger than in No. 3 having the spray distance of 180 mm. This means that No. 1 having the spray distance of 70 mm and No. 2 having the spray distance of 120 mm have more excellent heat shielding properties than No. 3 having the spray distance of 180 mm.

Further, although not shown in the drawings, with respect to each test piece after the molten salt penetration test described above, the penetration state of the molten salt into the film was examined by the presence state of Na in the film cross section. That is, when the amount of Na in the film cross section was examined by surface analysis using an electron probe micro analyzer (EPMA), in No. 1 or No. 2 in which the spray distance is short, it was confirmed that the penetration of Na was significantly reduced.

In contrast, in No. 3 in which the spray distance is long and No. 4 which is the conventional material using YSZ, it was confirmed that a large amount of Na permeated over the entire film.

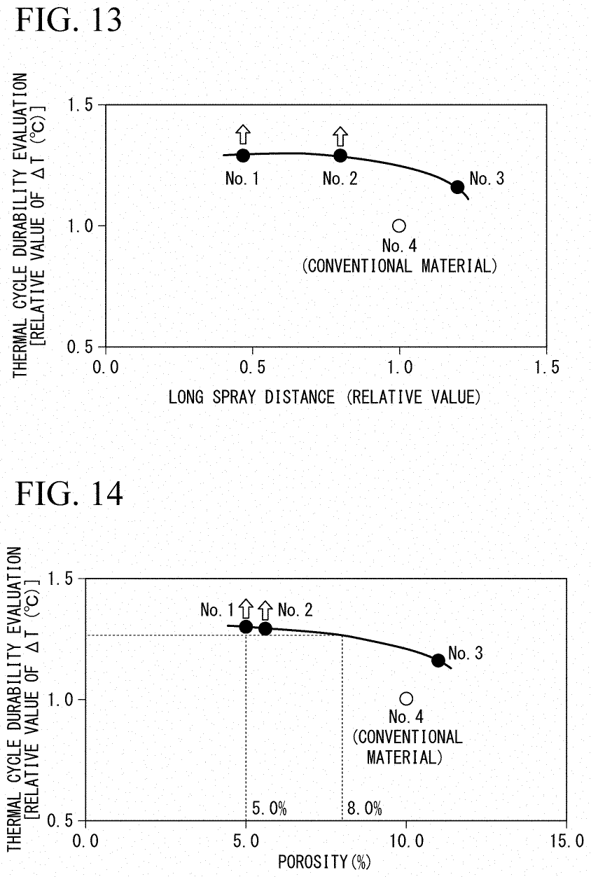

Further, with respect to the respective test pieces as described above, the relationship between the spray distance and the durability of the thermal barrier coating film in the thermal cycle test is shown in FIG. 13, and the relationship between the porosity in the thermal barrier coating film and the durability of the thermal barrier coating film in the thermal cycle test is shown in FIG. 14.

Here, in the thermal cycle durability evaluation in FIGS. 13 and 14, the peeling limit temperature difference ΔT in TBC of No. 4 which is the conventional material was set as the reference value 1, and the thermal cycle durability evaluation was shown by the relative values of ΔT of the test pieces of No. 1 to No. 3 with respect to the reference value. With respect to the porosity of the top coat layer in each test piece, an optical micrograph (for example, FIG. 15) of the cross section was binarized by image processing, as already described, pore portions were extracted from the binarized image (for example, FIG. 16), and the porosity was determined from the area ratio of the pore portions.

As described above, in No. 1 and No. 2 using YbSZ, it was confirmed that the temperature difference ΔT in TBC of the limit which does not cause peeling after 1000 cycles under a severe molten salt presence environment was about 30% superior with the limit temperature ΔT in the molten salt of No. 4 which is the conventional material using normal YSZ being 1, and extremely high durability was exhibited.

On the other hand, also in No. 3 using YbSZ and having a long spray distance, although it exhibits high durability, compared to No. 4 using normal YSZ, the durability is slightly lower, compared to No. 1 and No. 2.

Further, from FIGS. 13 and 14, it can be read that even in the same thermal spray material, the porosity of the film changes by changing the spray distance.

Then, from FIG. 14, it is clear that the limit temperature difference ΔT which does not cause peeling even after 1000 cycles, in the test pieces No. 1 and No. 2 in which the porosity is within the range (5% or more and less than 8%) of the present invention, among the test pieces of No. 1 to No. 3 using YbSZ, is larger than that in the test piece No. 3 in which the porosity exceeds the range of the present invention, and the durability is excellent.

Here, a target limit temperature difference ΔT for securing the thermal cycle durability in the molten salt aims at improvement of 25% or more over the conventional material using YSZ. In that case, it can be seen from FIG. 14 that the porosity needs to be controlled to less than 8%. This is a result different from the fact that in PTL 2 described above, in a case of using YbSZ under a normal gas-fired gas turbine environment (an environment in which the molten salt is not present), a porosity in a range of 8 to 15% exhibits high thermal cycle durability, and is a newly found finding.

That is, if the porosity decreases, the Young's modulus of the film rises, and thus thermal stress during operation increases, and therefore, in general, it is believed that if the porosity becomes low, the durability decreases. However, in a case of using low-quality fuel, it was found that the influence of molten salt penetration into a pore is greater and in that case, the optimum porosity is different from the conventionally called optimum range of porosity. In addition, it is believed that controlling the particle size distribution and reducing layered defects unique to thermal spraying also results in high durability.

Here, it was described that 1.25 (25% improvement over the conventional material No. 4) is targeted as the value of ΔT after 1000 cycles in the thermal cycle test. However, if the porosity is less than 8%, ΔT of 1.25 or more can be secured, and therefore, in the present invention, the upper limit of the porosity is set to be less than 8%.

The preferred embodiment and the experimental example of the present invention have been described above. However, the embodiment and the experimental example are merely examples within the scope of the gist of the present invention, and additions, omissions, substitutions, and other changes of the configurations can be made within a scope which does not depart from the gist of the present invention. That is, the present invention is not limited by the above description and is limited only by the appended claims, and of course, the present invention can be appropriately changed within the scope.

### REFERENCE SIGNS LIST

1: gas turbine
2: compressor
3: combustor
4: turbine main body
5: rotor
6: casing
7: turbine blade
8: turbine vane
10: base material
11: coating layer
12: bonding layer (bonding coat layer)
13: thermal barrier coating film (top coat layer)

1. A thermal barrier coating film including a ceramic material thermally sprayed and formed on a base material made of a heat resistant alloy constituting a turbine member in a heavy oil fired gas turbine engine using low-quality fuel,
wherein ytterbia partially stabilized zirconia is used as the ceramic material of the film, and a porosity of the thermal barrier coating film is 5% or more and less than 8%.

2. The thermal barrier coating film according to claim 1, wherein the porosity is in a range of 5% to 6%.

3. The thermal barrier coating film according to claim 1, wherein the thermal barrier coating film in which thermal spray powder which has a particle size distribution in which a 10% particle diameter in a cumulative particle size distribution is 30 μm or more and 100 μm or less, is used as ceramic spray powder for film formation,
the thermal spray powder has a maximum particle diameter of 150 μm or less, and
the thermal spray powder contains particles having a particle diameter of 30 μm at a ratio of 3% or less and particles having a particle diameter of 40 μm at a ratio of 8% or less.

4. A turbine member comprising:
the thermal barrier coating film according to claim 1 formed on a base material.

5. The turbine member according to claim 4, wherein the thermal barrier coating film is formed on a surface of the base material with a bonding layer interposed therebetween.

6. (canceled)
